(19) United States
(12) Patent Application Publication
(10) Pub. No.: US 2002/0090077 A1
(43) Pub. Date: Jul. 11, 2002

(54) Graffiti entry in phone dialer

(76) Inventors: Christine Park Burke, San Diego, CA (US); Stephen A. Sprigg, Poway, CA (US)

Correspondence Address: Qualcomm Incorporated, Patents Department, 5775 Morehouse Drive, San Diego, CA, 92121-1714, US

(21) Appl. No.: 09/758,329

(22) Filed: Jan. 10, 2001

(51) Int. Cl. H04M 1/00; H04M 3/00

(52) U.S. Cl. 379/353

(57) ABSTRACT

A graphical user interface (GUI) (202) converts stylus strokes (106) into characters (204), which are applied to a dialer (206) in a telephone. The dialer converts the characters into dial signals (108), such as tone combinations or (in older machines) pulse strings, which dial the indicated phone number.

### TECHNICAL FIELD

This invention relates to telephony, and has particular relation to dialing a phone call.

### BACKGROUND ART

Telephone networks originally required a human operator. A person wishing to place a call would tell the operator the name or number of person sought to be called, and the operator would put the call through. Later, pulse dialers—driven by actual mechanical rotary dials—replaced the operator. Rotating the dial would cause the dialer to produce a pulse string, and automatic machinery in the telephone network would interpret a sequence of pulse strings to put the call through.

After that, tone dialing became the norm. Depressing a key on a keypad would cause a dialer within the telephone to generate a tone, or (more precisely) a combination of tones. Electronic devices in the telephone network would interpret a sequence of tone combinations to put the call through. Despite the abolition of the mechanical rotary dial, the process continued to be called “dialing” a number.

Each pulse string in the old networks, representing a single dialed digit, may be viewed as a dial signal. Similarly, each tone combination in the more modem networks, similarly representing a single dialed digit, may be viewed as a dial signal. A sequence of dial signals (including pauses when appropriate) forms the telephone number, in a network-useable format. The term “dial signal” is used herein distinctly from the term “dial tone”, which indicates only that the network is ready to receive a sequence of dial signals.

### BRIEF DISCLOSURE OF THE INVENTION

This invention extends dial signaling to the graphical user interface, or GUI. Numbers can be drawn on a touch-screen with a stylus, as in a conventional Personal Digital Assistant, or PDA. The PALM brand of PDA, manufactured by 3Com Corporation and using the GRAFFITI brand of GUI, is suitable. Such numbers are converted to dial signals—tone combinations or pulse strings—and are used to place a phone call.

If desired, letters can be input to the touch-screen. Each letter is then converted to a number, which is then used to generate the appropriate dial signal. Alternatively, the appropriate dial signal may be generated directly from the letter.

Graphical input can also be used to signal a pause. This is of lesser importance when each character, whether number or letter, is used to immediately generate a dial signal. Often, however, the telephone user prefers to store the telephone number before dialing it, and to see the number (to ensure that it is correct) before pressing a “Talk” or “Dial” button. Indeed, most wireless telephone networks require such storage. In such situations, the user appreciates the visual feedback that a pause will be made when appropriate, and the telephone is constructed to actually make such a pause.

### BRIEF DESCRIPTION OF THE DRAWINGS

FIG. 1 is a block diagram of a telephone according to the present invention.

FIG. 2 is block diagram of graphic-to-character conversion.

FIG. 3 is a block diagram of intermediate conversion of alpha characters to numeric characters and then to dial signals.

FIG. 4 is a block diagram of direct conversion of alpha characters to dial signals.

FIG. 5 is a block diagram of the conversion of a pause character to a pause dial signal.

FIG. 6 is a block diagram of a method according to the present invention.

FIG. 7 is a block diagram of a method using a stylus and a touch-screen.

FIG. 8 is a block diagram of a method using an intermediate character conversion step.

FIG. 9 is a block diagram of a method using an intermediate alpha-to-numeric conversion step.

FIG. 10 is a block diagram of a method avoiding an intermediate alpha-to-numeric conversion step.

FIG. 11 is a block diagram of a pause-character-to-pause-dial-signal method.

### DETAILED DESCRIPTION

FIG. 1 is a block diagram of a telephone according to the present invention. A telephone (100) includes a dialer (102) which includes a graphical user interface (GUI) (104). Graphical information (106) is applied to the GUI (104) and the dialer (102) converts it to a dial signal (108). The GUI (104) is preferably a touch-screen, operated by a stylus (110). The touch-screen (104) and stylus (110) are therefore considered to be part of the dialer (102).

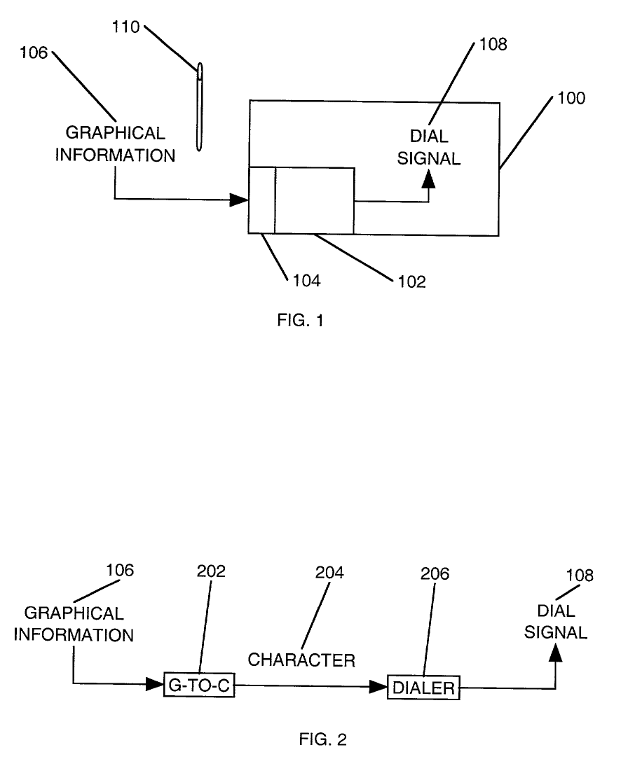

FIG. 2 is block diagram of graphic-to-character conversion. In this embodiment of the invention, the dialer (102) of FIG. 1 is instead viewed as excluding the GUI (104). Thus, the graphical information (106) is applied to a graphic-to-character converter (202), which converts it to a character (204). It is this character (204), and not the graphical information (106) per se, which is applied to the dialer (206), which produces the dial signal (108).

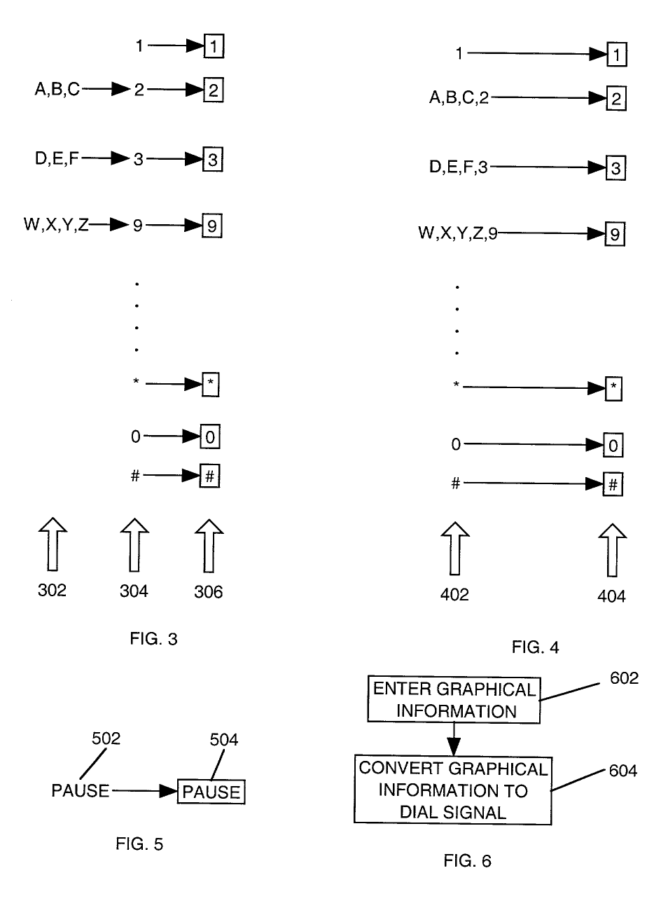

FIG. 3 is a block diagram of intermediate conversion of alpha characters to numeric characters and then to dial signals. Some numeric character of the convention telephone keypad, such as the “1” and the “#”, are not associated with any alpha characters. Other numeric characters are conventionally associated with alpha characters. The “3”, for example, is associated with the “D”, the “E”, and the “F”. Thus, if the graphic-to-character converter (202) generates an alpha character (302), the alpha character (302) is converted into a numeric character (304), which is in turn converted into a dial signal (306). If, on the other hand, the graphic-to-character converter (202) generates a numeric character (304), it is directly converted into the dial signal (306).

FIG. 4 is a block diagram of direct conversion of alpha characters to dial signals. All characters (402), whether alpha or numeric, are converted directly into a dial signal (404).

FIG. 5 is a block diagram of the conversion of a pause character (502) to a pause dial signal (504). FIG. 5 is included since a pause character is not really either alpha or numeric. A pause dial signal is a pause between other dial signals.

FIG. 6 is a block diagram of a method according to the present invention. Graphical information is entered (602), and then is converted (604) into a dial signal. It parallels FIG. 1, in that no intermediate conversion into a character is required. See FIG. 8.

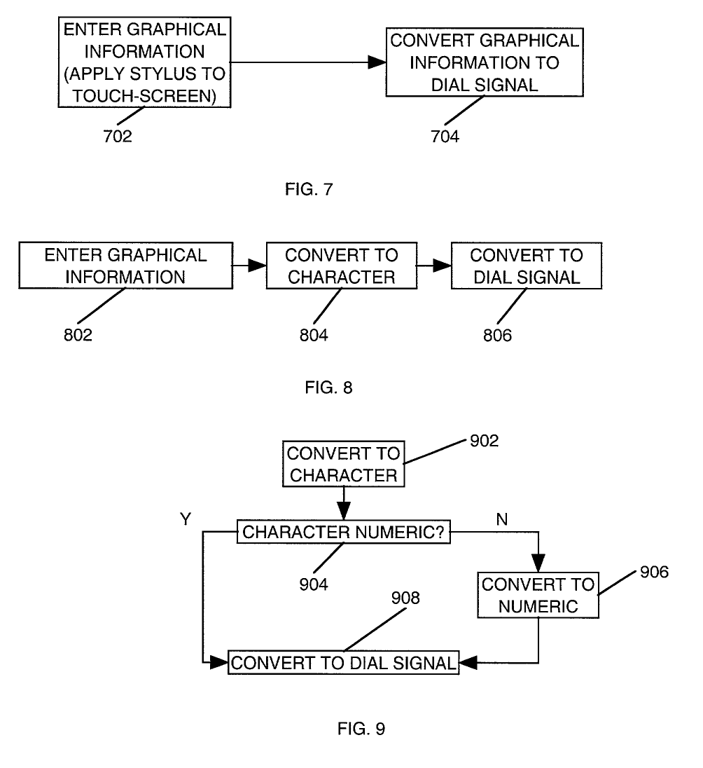

FIG. 7 is a block diagram of a method using a stylus and a touch-screen. The entry of graphical information is accomplished by applying a stylus to a touch-screen (702). The follow-on conversion (702) is the same as the foregoing conversion (602).

FIG. 8 is a block diagram of a method using an intermediate character conversion step. It parallels FIG. 2. Graphical information is entered (802) and converted to a character (804). The character in turn is converted (806) to a dial signal.

FIG. 9 is a block diagram of a method using an intermediate alpha-to-numeric conversion step. Once graphical information has been converted (902) to a character, a determination is made (904) as to whether the character is numeric. If it is not numeric, it is converted (906) to a numeric character, which is then converted to a dial signal (908). If the character is numeric, it is converted to a dial signal (908) immediately. FIG. 9 parallels FIG. 3.

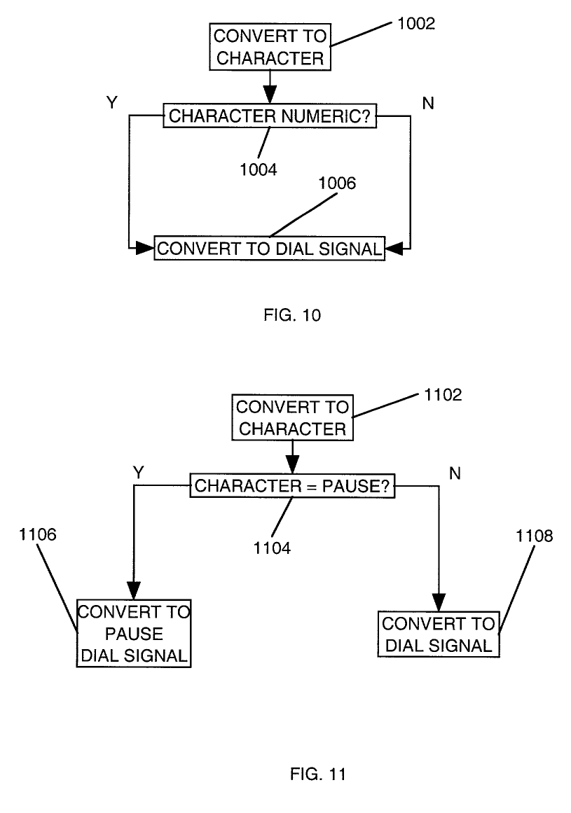

FIG. 10 is a block diagram of a method avoiding an intermediate alpha-to-numeric conversion step. Once the graphical information has been converted to a character (1002), it makes no difference (1004) whether the character is numeric. It is immediately converted to a dial signal (1006) in either case. FIG. 10 parallels FIG. 4.

FIG. 11 is a block diagram of a pause-character-to-pause-dial-signal method. Once the graphical information has been converted to a character (1102), a determination is made (1104) as to whether the character is a pause character. If it is, then it is converted (1106) to a pause dial signal; that is, a pause is inserted between other dial signals. If it is not, then it is converted (1108) to a regular dial signal.

Industrial Application

This invention is capable of exploitation in industry, and can be made and used, whenever is it desired to dial a telephone. The individual components of the apparatus and method shown herein, taken separate and apart from one another, may be entirely conventional, it being their combination that is claimed as the invention.

While various modes of apparatus and method have been described, the true spirit and scope of the invention are not limited thereto, but are limited only by the following claims and their equivalents, and such are claimed as the invention.

1. A telephone, wherein:
(a) the telephone includes a dialer, and
(b) the dialer is characterized in that it is constructed to:
(1) receive graphical information; and
(2) convert the graphical information into a dial signal.

2. The telephone of claim 1, wherein the dialer includes a touch-screen and a stylus.

3. A telephone, wherein:
(a) the telephone includes a dialer, and
(b) the telephone is characterized in that:
(1) the telephone further includes a graphic-to-character converter; and
(2) the dialer is constructed to:
(A) receive a sequence of characters from the graphic-to-character converter; and
(B) convert each character to a dial signal.

4. The telephone of claim 3, characterized in that it further includes means for, if the character is an alpha character:
(a) converting the alpha character into an associated numeric character; and
(b) converting the numeric character into the dial signal.

5. The telephone of claim 3, characterized in that it further includes means for, if the character is an alpha character, converting the alpha character into a dial signal associated with a numeric character which is associated with the alpha character.

6. The telephone of claim 3, characterized in that it further includes means for, if the character is a pause character, converting the pause character into a pause dial signal.

7. A method for dialing a telephone, wherein:
(a) the method includes a sequence of steps of producing a dial signal; and
(b) the method is characterized in that each step of producing a dial signal includes the steps of:
(1) entering graphical information;
(2) converting the graphical information to the dial signal.

8. The method of claim 7, characterized in that the step of entering graphical information includes the step of applying a stylus to a touch-screen.

9. The method of claim 7, wherein the step of converting the graphical information to the dial signal is characterized in that it includes the steps of:
(a) converting the graphical information into a character; and
(b) converting the character into the dial signal.

10. The method of claim 9, characterized in that it further includes the steps of, if the character is an alpha character:
(a) converting the alpha character into an associated numeric character; and
(b) converting the numeric character into the dial signal.

11. The method of claim 9, characterized in that it further includes the step of, if the character is an alpha character, converting the alpha character into a dial signal associated with a numeric character which is associated with the alpha character.

12. The method of claim 9, characterized in that it further includes the step of, if the character is a pause character, converting the pause character into a pause dial signal.
